(19) United States
(12) Patent Application Publication
(10) Pub. No.: US 2024/0236419 A9
(43) Pub. Date: Jul. 11, 2024

(54) INSTALLATION AND SCALING FOR VCORES

(71) Applicant: ARRIS Enterprises LLC, Suwanee, GA (US)

(72) Inventors: Santhana CHARI, Johns Creek, GA (US); David E. VIRAG, Johns Creek, GA (US); Michael J. EMMENDORFER, Saint Peters, MO (US); Thomas J. CLOONAN, Lisle, IL (US); Mircea ORBAN, Toronto (CA); Arpad JORDAN, Winchester (GB); Shawn WARNER, Pepperell, MA (US); David GRUBB, Doylestown, PA (US)

(73) Assignee: ARRIS Enterprises LLC, Suwanee, GA (US)

(21) Appl. No.: 18/382,978

(22) Filed: Oct. 23, 2023

Related U.S. Application Data
(63) Continuation of application No. 17/227,137, filed on Apr. 9, 2021, now abandoned.
(60) Provisional application No. 63/024,977, filed on May 14, 2020.
(60) Provisional application No. 63/071,957, filed on Aug. 28, 2020.
(60) Provisional application No. 63/071,945, filed on Aug. 28, 2020.

(51) Int. Cl. H04N 21/45; H04L 41/0897

(52) U.S. Cl. CPC H04N 21/4516; H04L 41/0897

(57) ABSTRACT

A cable distribution system includes a head end connected to a plurality of customer devices through a transmission network that includes a first remote physical device, where the first remote physical device includes remote physical layer processing, that converts digital data to analog data suitable for the plurality of customer devices, where the head end includes at least one server each of which includes a respective processor.

### CROSS REFERENCE TO RELATED APPLICATIONS

This application is a continuation of U.S. patent application Ser. No. 17/227,137 filed on Apr. 9, 2021, which claims the benefit of U.S. Provisional Patent Application No. 63/024,977 filed May 14, 2020; claims the benefit of U.S. Provisional Patent Application No. 63/071,957 filed Aug. 28, 2020; claims the benefit of U.S. Provisional Patent Application No. 63/071,945 filed Aug. 28, 2020.

### BACKGROUND

The subject matter of this application relates to vCores.

Cable Television (CATV) services provide content to large groups of customers (e.g., subscribers) from a central delivery unit, generally referred to as a “head end,” which distributes channels of content to its customers from this central delivery unit through an access network comprising a hybrid fiber coax (HFC) cable plant, including associated components (nodes, amplifiers and taps). Modern Cable Television (CATV) service networks, however, not only provide media content such as television channels and music channels to a customer, but also provide a host of digital communication services such as Internet Service, Video-on-Demand, telephone service such as VoIP, home automation/security, and so forth. These digital communication services, in turn, require not only communication in a downstream direction from the head end, through the HFC, typically forming a branch network and to a customer, but also require communication in an upstream direction from a customer to the head end typically through the HFC network.

To this end, CATV head ends have historically included a separate Cable Modem Termination System (CMTS), used to provide high speed data services, such as cable Internet, Voice over Internet Protocol, etc. to cable customers and a video headend system, used to provide video services, such as broadcast video and video on demand (VOD). Typically, a CMTS will include both Ethernet interfaces (or other more traditional high-speed data interfaces) as well as radio frequency (RF) interfaces so that traffic coming from the Internet can be routed (or bridged) through the Ethernet interface, through the CMTS, and then onto the RF interfaces that are connected to the cable company's hybrid fiber coax (HFC) system. Downstream traffic is delivered from the CMTS to a cable modem and/or set top box in a customer's home, while upstream traffic is delivered from a cable modem and/or set top box in a customer's home to the CMTS. The Video Headend System similarly provides video to either a set-top, TV with a video decryption card, or other device capable of demodulating and decrypting the incoming encrypted video services. Many modern CATV systems have combined the functionality of the CMTS with the video delivery system (e.g., EdgeQAM—quadrature amplitude modulation) in a single platform generally referred to an Integrated CMTS (e.g., Integrated Converged Cable Access Platform (CCAP))—video services are prepared and provided to the I-CCAP which then QAM modulates the video onto the appropriate frequencies. Still other modern CATV systems generally referred to as distributed CMTS (e.g., distributed Converged Cable Access Platform) may include a Remote PHY (or R-PHY) which relocates the physical layer (PHY) of a traditional Integrated CCAP by pushing it to the network's fiber nodes (R-MAC PHY relocates both the MAC and the PHY to the network's nodes). Thus, while the core in the CCAP performs the higher layer processing, the R-PHY device in the remote node converts the downstream data sent from the core from digital-to-analog to be transmitted on radio frequency to the cable modems and/or set top boxes, and converts the upstream radio frequency data sent from the cable modems and/or set top boxes from analog-to-digital format to be transmitted optically to the core.

### BRIEF DESCRIPTION OF THE DRAWINGS

For a better understanding of the invention, and to show how the same may be carried into effect, reference will now be made, by way of example, to the accompanying drawings, in which:

FIG. 1 illustrates an integrated Cable Modem Termination System.

FIG. 2 illustrates a distributed Cable Modem Termination System.

FIG. 3 illustrates a layered network processing stack.

FIG. 4 illustrates a server system with a resource allocation manager and a container orchestration system.

FIG. 5 illustrates a server system with containers and a container orchestration system.

FIG. 6 illustrates a server system with a resource allocation manager, a container orchestration system, and a monitoring system.

FIG. 7 illustrates a pair of vCores and loading on a set of remote physical devices.

FIG. 8 illustrates migration of all remote physical devices of a vCore.

FIG. 9 illustrates migration of less than all remote physical devices of a vCore.

FIG. 10 illustrates migration of a remote physical device from a source server to a destination server.

FIG. 11 illustrates augmentation of capacity for vCores and/or server.

FIG. 12 illustrates a vCore and multiple remote physical devices.

FIG. 13 illustrates multiple vCores and multiple remote physical devices.

FIG. 14 illustrates reassignment of a remote physical device from a source vCore to a destination vCore.

FIG. 15 illustrates bandwidth usage, physical network bandwidth, and virtual network bandwidth.

FIG. 16 illustrates resource pools.

FIG. 17 illustrates a resource deployment system.

### DETAILED DESCRIPTION

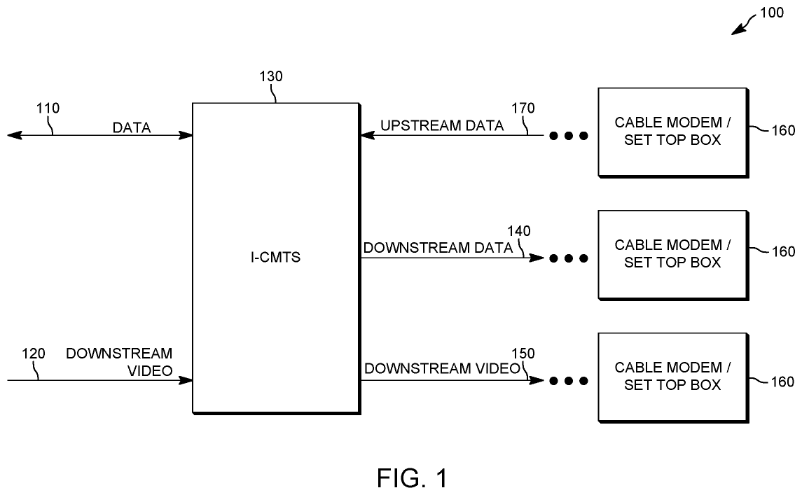

Referring to FIG. 1, an integrated CMTS (e.g., Integrated Converged Cable Access Platform (CCAP)) 100 may include data 110 that is sent and received over the Internet (or other network) typically in the form of packetized data. The integrated CMTS 100 may also receive downstream video 120, typically in the form of packetized data from an operator video aggregation system. By way of example, broadcast video is typically obtained from a satellite delivery system and pre-processed for delivery to the subscriber though the CCAP or video headend system. The integrated CMTS 100 receives and processes the received data 110 and downstream video 120. The CMTS 130 may transmit downstream data 140 and downstream video 150 to a customer's cable modem and/or set top box 160 through a RF distribution network, which may include other devices, such as amplifiers and splitters. The CMTS 130 may receive upstream data 170 from a customer's cable modem and/or set top box 160 through a network, which may include other devices, such as amplifiers and splitters. The CMTS 130 may include multiple devices to achieve its desired capabilities.

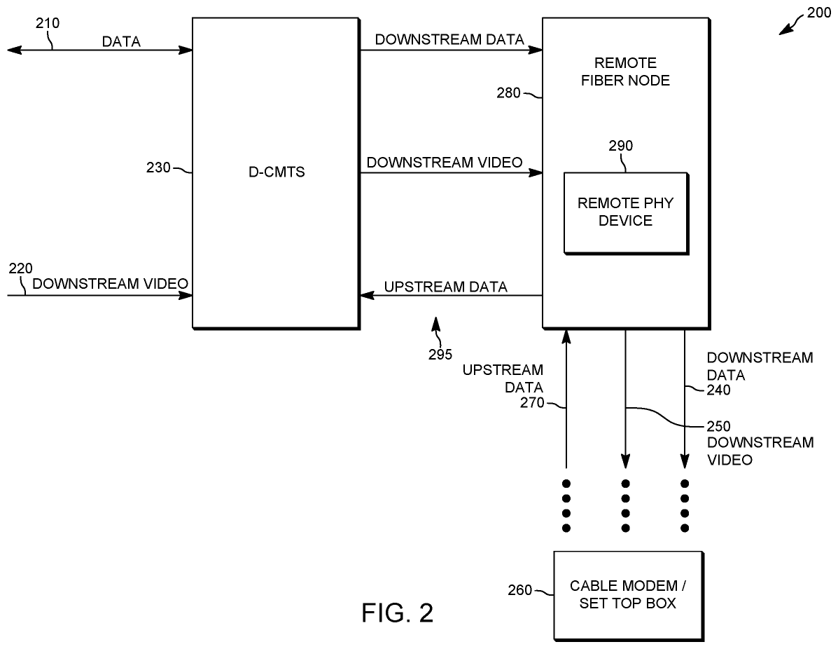

Referring to FIG. 2, as a result of increasing bandwidth demands, limited facility space for integrated CMTSs, and power consumption considerations, it is desirable to include a Distributed Cable Modem Termination System (D-CMTS) 200 (e.g., Distributed Converged Cable Access Platform (CCAP)). In general, the CMTS is focused on data services while the CCAP further includes broadcast video services. The D-CMTS 200 distributes a portion of the functionality of the I-CMTS 100 downstream to a remote location, such as a fiber node, using network packetized data. An exemplary D-CMTS 200 may include a remote PHY architecture, where a remote PHY (R-PHY) is preferably an optical node device that is located at the junction of the fiber and the coaxial. In general, the R-PHY often includes the PHY layers of a portion of the system. The D-CMTS 200 may include a D-CMTS 230 (e.g., core) that includes data 210 that is sent and received over the Internet (or other network) typically in the form of packetized data. The D-CMTS 200 may also receive downstream video 220, typically in the form of packetized data from an operator video aggregation system. The D-CMTS 230 receives and processes the received data 210 and downstream video 220. A remote Fiber node 280 preferably include a remote PHY device 290. The remote PHY device 290 may transmit downstream data 240 and downstream video 250 to a customer's cable modem and/or set top box 260 through a network, which may include other devices, such as amplifier and splitters. The remote PHY device 290 may receive upstream data 270 from a customer's cable modem and/or set top box 260 through a network, which may include other devices, such as amplifiers and splitters. The remote PHY device 290 may include multiple devices to achieve its desired capabilities. The remote PHY device 290 primarily includes PHY related circuitry, such as downstream QAM modulators, upstream QAM demodulators, together with psuedowire logic to connect to the D-CMTS 230 using network packetized data. The remote PHY device 290 and the D-CMTS 230 may include data and/or video interconnections, such as downstream data, downstream video, and upstream data 295. It is noted that, in some embodiments, video traffic may go directly to the remote physical device thereby bypassing the D-CMTS 230. In some cases, the remote PHY and/or remote MAC PHY functionality may be provided at the head end.

By way of example, the remote PHY device 290 may covert downstream DOCSIS (i.e., Data Over Cable Service Interface Specification) data (e.g., DOCSIS 1.0; 1.1; 2.0; 3.0; 3.1; and 4.0 each of which are incorporated herein by reference in their entirety), video data, out of band signals received from the D-CMTS 230 to analog for transmission over RF or analog optics. By way of example, the remote PHY device 290 may convert upstream DOCSIS, and out of band signals received from an analog medium, such as RF or linear optics, to digital for transmission to the D-CMTS 230. As it may be observed, depending on the particular configuration, the R-PHY may move all or a portion of the DOCSIS MAC and/or PHY layers down to the fiber node.

I-CMTS devices are typically custom built hardware devices that consist of a single chassis that include a series of slots, each of which receives a respective line card with a processor, memory, and other computing and networking functions supported thereon. Each of the line cards include the same hardware configuration, processing capabilities, and software. Each of the line cards performs the functions of the I-CMTS device, including the MAC and PHY functionality. As the system increasingly scales to support additional customers, additional line cards are included with the system to expand the processing capability of the system. Unfortunately, it is problematic to dynamically scale the number of line cards in a real-time manner to meet the demands of a particular network.

The computational power of microprocessor based commercial off the shelf (COTS) server platforms are increasing while the expense of such systems is decreasing over time. With such systems, a computing system may be, if desired, virtualized and operated using one or more COTS server, generally referred to herein as a virtual machine. Using container technologies running on the COTS server and/or virtual machine, the COTS server may operate with only a single operating system. Each of the virtualized applications may then be isolated using software containers, such that the virtualized application may not see and are not aware of other virtualized applications operating on the same machine. Typically, each COTS server includes one or more Intel/AMD processors (or other processing devices) with associated memory and networking capabilities running an operating system software. Typically, the COTS servers include a framework and an operating system where user applications are run on such framework and the operating system is abstracted away from the actual operating system. Each virtual machine may be instantiated and operated as one or more software applications running on a COTS server. A plurality of software containers may be instantiated and operated on the same COTS server and/or the same virtual machine. A plurality of COTS servers is typically included in one or more data centers, each of which are in communication with one another. A plurality of COTS server may be located in different geographic areas to provide geo-redundancy. In some embodiments, the container may include the same functionality as a virtual machine, or vice versa. In some embodiments, a grouping of containerized components, generally referred to as a pod, may be in the form of a virtual machine.

In some embodiments, the COTS servers may be “bare metal” servers that typically include an operating system thereon together with drivers and a portion of a container orchestration system. One or more containers are then added to the “bare metal” server while being managed by the container orchestration system. The container orchestration system described herein may likewise perform as, and be referred to as, a virtual machine orchestration system, as desired. In some embodiments, “bare metal” servers may be used with pods running on the operating system thereon together with drivers and a container orchestration system. In some embodiments, virtual machines may be omitted from the COTS servers.

Selected software processes that are included on a line card and/or a remote PHY device may be run on a “bare metal” server and/or virtual machine, including software containers, running on a COTS server, including both “active” and “back-up” software processes. The functionality provided by such a “bare metal” server and/or virtual machine may include higher level functions such as for example, packet processing that includes routing Internet packet provisioning, layer 2 virtual private networking which operates over pseudowires, and multiprotocol label switching routing. The functionality provided by such a “bare metal” server and/or virtual machine may include DOCSIS functions such as for example, DOCSIS MAC and encapsulation, channel provisioning, service flow management, quality of service and rate limiting, scheduling, and encryption. The functionality provided by such a “bare metal” server and/or virtual machine may include video processing such as for example, EQAM and MPEG processing.

Each of the COTS servers and/or the virtual machines and/or software containers may contain different hardware profiles and/or frameworks. For example, each of the COTS servers and/or “bare metal” servers and/or virtual machines and/or software containers may execute on different processor types, different number of processing cores per processor, different amounts of memory for each processor type, different amounts of memory per processing core, different cryptographic capabilities, different amounts of available off-processor memory, different memory bandwidth (DDR) speeds, and varying types and capabilities of network interfaces, such as Ethernet cards. In this manner, different COTS servers and/or “bare metal” servers and/or virtual machines and/or software containers may have different processing capabilities that vary depending on the particular hardware. Each of the COTS servers and/or “bare metal” servers and/or the virtual machine and/or software containers may contain different software profiles. For example, each of the COTS servers and/or “bare metal” servers and/or virtual machines and/or software containers may include different software operating systems and/or other services running thereon, generally referred to herein as frameworks. In this manner, different COTS servers and/or “bare metal” servers and/or virtual machines and/or software containers may have different software processing capabilities that vary depending on the particular software profile.

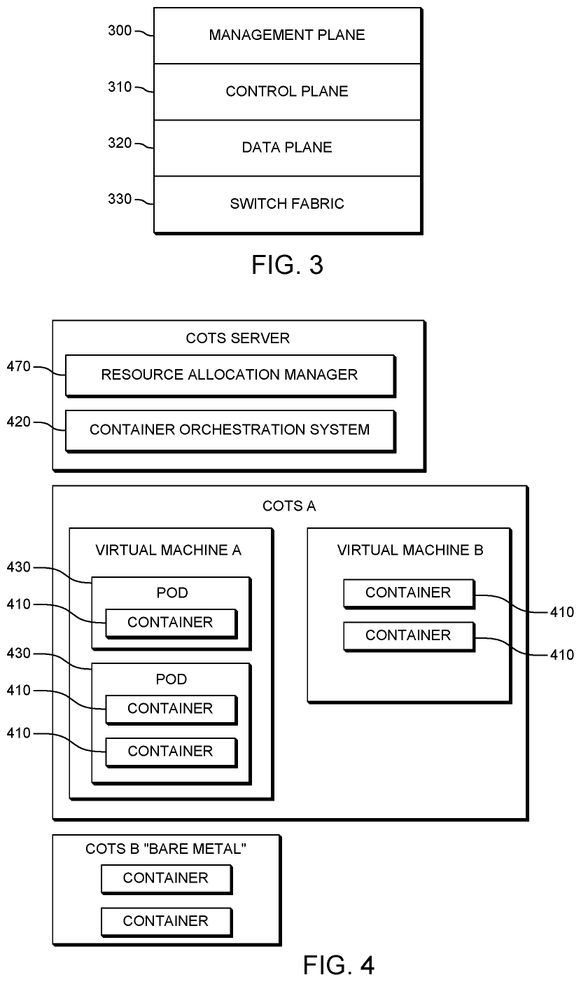

Referring to FIG. 3, for data processing and for transferring data across a network, the architecture of the hardware and/or software may be configured in the form of a plurality of different planes, each of which performing a different set of functionality. In relevant part the layered architecture may include different planes such as a management plane 300, a control plane 310, a data plane 320, and switch fabric 330 to effectuate sending and receiving packets of data.

For example, the management plane 300 may be generally considered as the user interaction or otherwise the general software application being run. The management plane typically configures, monitors, and provides management, and configuration served to all layers of the network stack and other portions of the system.

For example, the control plane 310 is a component to a switching function that often includes system configuration, management, and exchange of routing table information and forwarding information. Typically, the exchange of routing table information is performed relatively infrequently. A route controller of the control plane 310 exchanges topology information with other switches and constructs a routing table based upon a routing protocol. The control plane may also create a forwarding table for a forwarding engine. In general, the control plane may be thought of as the layer that makes decisions about where traffic is sent. Since the control functions are not performed on each arriving individual packet, they tend not to have a strict speed constraint.

For example, the data plane 320 parses packet headers for switching, manages quality of service, filtering, medium access control, encapsulations, and/or queuing. As a general matter, the data plane carriers the data traffic, which may be substantial in the case of cable distribution networks. In general, the data plane may be thought of as the layer that primarily forwards traffic to the next hop along the path to the selected destination according to the control plane logic through the switch fabric. The data plane tends to have strict speed constraints since it is performing functions on each arriving individual packet.

For example, the switch fabric 330 provides a network topology to interconnect network nodes via one or more network switches.

As the system increasingly scales to support additional customers, additional COTS servers and/or “bare metal” servers and/or virtual machines and/or software containers are included with the system to expand the processing capability of the overall system. To provide processing redundancy, one or more additional COTS servers and/or “bare metal” servers and/or virtual machines and/or software containers may be included that are assigned as “back-up” which are exchanged for an “active” process upon detection of a failure event. The scaling of the data plane 320 on COTS servers and/or “bare metal” servers and/or virtual machines and/or software containers to service dynamically variable processing requirements should be performed in such a manner that ensures sufficiently fast processing of data packets and sufficient bandwidth for the transmission of the data packets to ensure they are not otherwise lost.

It is desirable to virtualize the data plane, and in particular all or a portion of the Remote PHY functionality on a COTS server and/or “bare metal” servers. In this manner, the MAC cores for the cable distribution system may run on COTS servers and/or “bare metal” servers. By way of reference herein, a virtualized Remote PHY MAC Core may be referred to herein as a vCore instance.

Referring to FIG. 4, it is desirable to incorporate platform as a service that uses operating system level virtualization to deliver software in packages, generally referred to as containers 410. Each of the containers are isolated from one another and bundle their own software, libraries, and configuration files. The containers may communicate with one another using defined channels. As a general matter, one or more applications and its dependencies may be packed in a virtual container that can run on a COTS server and/or “bare metal” server and/or a virtual machine. This containerization increases the flexibility and portability on where the application may run, such as an on-premises COTS server, a “bare metal” server, a public cloud COTS server, a private cloud COTS server, or otherwise. With each container being relatively lightweight, a single COTS server and/or “bare metal” server and/or a virtual machine operating on a COTS server and/or “bare metal” server may run several containers simultaneously. In addition, the COTS server and/or “bare metal” server and/or the virtual machine and/or the containers may be distributed within the cable distribution system.

A COTS server and/or “bare metal” server and/or a virtual machine may include a container orchestration system 420 for automating the application deployment, scaling, and management of the containers 410 across one or more COTS servers and/or “bare metal” servers and/or virtual machines. Preferably the computing device running the container orchestration system 420 is separate from the computing device providing the containers for the dataplane applications. It is to be understood that the virtual machine illustrated in FIG. 4 may be omitted, such as the COTS B. The application deployment, scaling, and management of the containers may include clusters across multiple hosts, such as multiple COTS servers. The deployment, maintaining, and scaling, of the containers may be based upon characteristics of the underlying system capabilities, such as different processor types, different number of processing cores per processor, different amounts of memory for each processor type, different amounts of memory per processing core, different amounts of available off-processor memory, different memory bandwidth (DDR) speeds, different frameworks, and/or varying types and capabilities of network interfaces, such as Ethernet cards. Moreover, the container orchestration system 420 may allocate different amounts of the underlying system capabilities, such as particular processor types, a selected number of processors (e.g., 1 or more), a particular number of processing cores per selected processor, a selected amount of memory for each processor type, a selected amount of memory per processing core, a selected amount of available off-processor memory, a selected framework, and/or a selected amount and/or type of network interface(s), such as Ethernet cards. A corresponding agent for the container orchestration system 420 may be included on each COTS server (e.g., COTS A and/or COTS B).

The container orchestration system 420 may include a grouping of containerized components, generally referred to as a pod 430. A pod consists of one or more containers that are co-located on the same COTS server and/or “bare metal” server and/or the same virtual machine, which can share resources of the same COTS server and/or “bare metal” server and/or same virtual machine. Each pod 430 is preferably assigned a unique pod IP address within a cluster, which allows applications to use ports without the risk of conflicts. Within the pod 430, each of the containers may reference each other based upon a localhost or other addressing service, but a container within one pod preferably has no way of directly addressing another container within another pod, for that, it preferably uses the pod IP address or otherwise an addressing service.

A traditional D-CMTS RPHY Core may be implemented as a speciality built appliance including both software and hardware to achieve desired performance characteristics, such as ensuring the timing of the transfer of data packets. The speciality built appliance is not amenable to automatic deployment nor automatic scaling due to the fixed nature of its characteristics. In contrast to a speciality built appliance, the vCore instance is preferably implemented in software operating on a COTS server and/or “bare metal” server on top of an operating system, such as Linux. The vCore instance is preferably implemented in a manner that readily facilitates automation techniques such as lifecycle management, flexible scaling, health monitoring, telemetry, etc. Unfortunately, running a vCore instance on a COTS server and/or “bare metal” server tends to result in several challenges, mostly related to the data plane components. One of the principal challenges involves ensuring that data is provided to the network in a timely and effective manner to achieve the real time characteristics of a cable data distribution environment. The cable data distribution environment includes real time constraints on the timing of data packet delivery, which is not present in typical web-based environments or database environments.

Each vCore instance is preferably implemented within a container, where the size (e.g., scale, memory, CPU, allocation, etc.) of each container translates into the amount of server hardware and software resources assigned to the particular vCore instance. The amount of server hardware and software resources assigned to each particular vCore instance is preferably a function of the number of groups of customers (e.g., service groups) and/or number of customers that the vCore instance can readily provide RPHY MAC Core services to. For example, a limited amount of server hardware and software resources may be assigned to a particular vCore instance that has a limited number of groups of customers and/or customers. For example, a substantial amount of server hardware and software resources may be assigned to a particular vCore instance that has a substantial number of groups of customers and/or customers. For example, selected server hardware resources are preferably allocated among the different vCore instances in a non-overlapping manner so that each vCore instance has a dedicated and predictable amount of server hardware resources. For example, selected software resources are preferably allocated among the different vCore instances in a non-overlapping manner so that each vCore instance has a dedicated and predictable amount of software resources.

For example, the number of CPU cores preferably assigned to each vCore instance (Cc) may be a function of the total USSG (upstream service groups—groups of customer modems and/or set top boxes) (USsg) and the total DSSG (downstream service groups—groups of customer modems and/or set top boxes) (DSsg) connected through that vCore instance. This may be represented as vCore: Cc=f₁ (USsg, DSsg). Other hardware and/or software characteristics may likewise be assigned, as desired.

For example, the network capacity assigned to each vCore instance (Cbw) may be a function of the of the total USSG (upstream service groups—groups of customer modems and/or set top boxes) (USsg) and the total DSSG (downstream service groups—groups of customer modems and/or set top boxes) (DSsg) connected to that vCore instance. This may be represented as Cbw=f₂ (USsg, DSsg). Other hardware and/or software characteristics may likewise be assigned, as desired.

The scaling of the vCore instance may refer to the capability to automatically create and deploy a vCore instance within a container on a COTS server and/or “bare metal” server and/or virtual machine that is appropriately sized to serve a particular set of remote physical devices and/or service groups (e.g., sets of cable customers) and/or cable customers. The scaling of the vCore instance may also include, in some cases, the capability to automatically modify the hardware and/or software characteristics of an existing vCore instance within a container on a COTS server and/or “bare metal” server and/or virtual machine to be appropriately sized to serve a modified particular set of remote physical devices and/or service groups (e.g., sets of cable customers) and/or cable customers.

A resource allocation manager 470 may assign or reallocate a suitable amount of hardware and software of the COTS server and/or “bare metal” server resources to each particular vCore instance (e.g., CPU cores, and/or memory, and/or network capacity). The amount of such COTS server and/or “bare metal” server hardware and software resources assigned to or reallocate to each vCore instance may be a function of its scale and also other features, such as various other resource allocations. A corresponding agent for the resource allocation manager 470 may be included on each COTS server (e.g., COTS A, COTS B).

The vCore instance includes data plane software for the transfer of data packets and other functions of the data plane. The data plane software may include a set of data plane libraries and network interface controller (NIC) drivers that are used to manage the data packets for the data plane. Preferably, the data plane software operates in user space, as opposed to Kernel space like typical network processing software, thus it does not make use of the operating system kernel and container management network drivers and plugins. For example, the data plane software may include a queue manager, a buffer manager, a memory manager, and/or a packet framework for packet processing. The data plane software may use CPU cores that are isolated from the Kernel, meaning that the operating system scheduled processes are not running on these isolated CPU cores. The separation of the CPU cores between the data plane software and the operating system software ensures that tasks performed by the operating system software does not interfere with the data plane software processing the data packets in a timely manner. In addition, the separation of the CPU cores between the data plane software and the operating system software enables both to use the same physical central processing unit, albeit different cores, of the same physical central processing unit. In addition, other hardware and/or software capabilities may likewise be separated, such as for example, selected processors (e.g., 1 or more), particular number of processing cores per selected processor, selected amount of memory for each processor type, selected amount of memory per processing core, selected amount of available off-processor memory, selected framework, and/or selected amount and/or type of network interface(s).

It is also desirable for each vCore instance to have dedicated network bandwidth capability apart from other vCore instances and the operating system software. To provide dedicated network bandwidth for a vCore instance, the physical network interface cards may be virtualized so that a plurality of different software applications can make use of the same network interface card, each with a guaranteed amount of bandwidth available. The network interface cards are preferably virtualized using a single root input/output virtualization technique (SR-IOV). The SR-IOV partitions the NIC physical functions (e.g., PFs) into one or more virtual functions (VFs). The capabilities of the PFs and VFs are generally different. In general, the PF supports queues, descriptions, offloads, hardware lock, hardware link control, etc. In general, the VF supports networking features based upon queues and descriptors.

The automated creation, deployment, and removal of vCore instances may be performed by the container orchestration system 420.

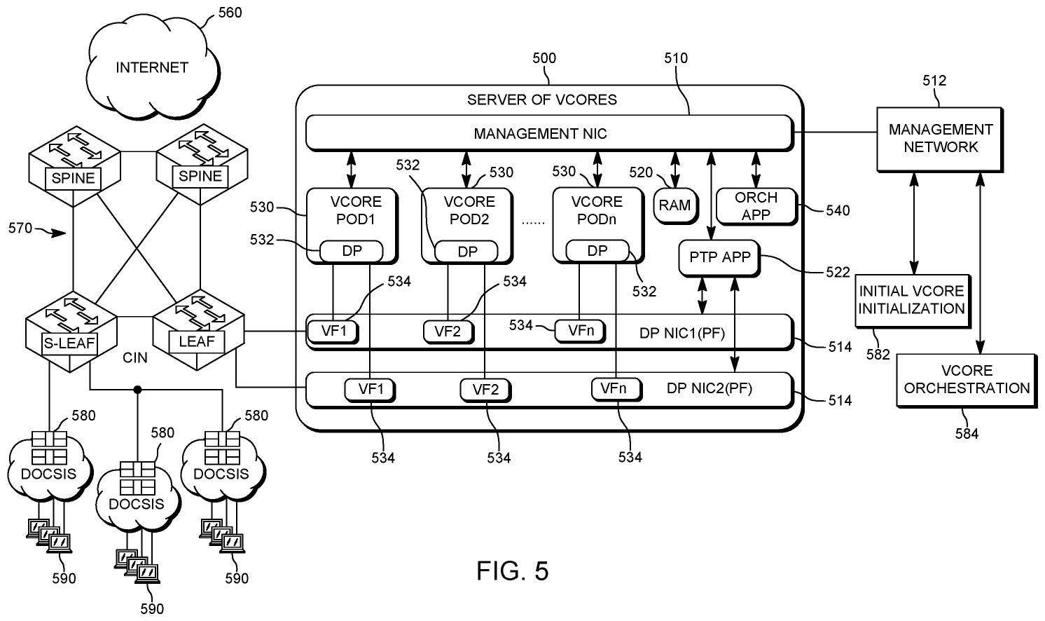

Referring to FIG. 5, the vCore instances 530 may operate on a COTS server and/or “bare metal” server 500 acting as a remote PHY MAC core for one or more remote physical devices connected over a converged interconnect network, normally located in the same hub. The vCore instances 530 may include data plane software 532. Each of the vCore instances 530 as generally referred to as a POD. In some cases, multiple vCores may be included in a POD. The COTS server 500 may communicate with the Internet 560, a set of networking switches 570, to remote physical devices 580, and the customers 590. The COTS server and/or “bare metal” server including the vCore instances operating thereon is typically a relatively high performance server that has one or more of the following characteristics:

Hardware:

At least one management NIC 510 is connected to, usually, a separate management network 512. The management NIC 510 is primarily used for orchestration and management of the server application, which may also manage the data traffic.

Preferably at least two (for redundancy) data plane NICs 514 (i.e., data plane physical network interfaces) together with SR-IOV and PTP (IEEE 1588) 522 are included for hardware timestamping capabilities of the data packets. The data plane NICs 514 are used to provide connectivity to the remote physical devices and the customer modems and/or set top boxes/consumer premises equipment behind such remote physical devices. The vCore instances 530 may each include a virtual function 534 network interface to each of the data plane NICs 514.

In addition, the hardware may include dedicated devices for DES encryption.

Software:

Preferably the operating system on the COTS server and/or “bare metal” server is a LINUX OS such as Ubuntu, Redhat, etc.

The COTS Server and/or “bare metal” server and/or virtual machine includes container software.

The COTS Server and/or “bare metal” server and/or virtual machine and/or other server includes at least a part of a container orchestration system.

The COTS Server and/or “bare metal” server and/or virtual machine and/or other server includes a resource allocation manager (RAM) 520 that manages, at least in part, the server allocation of software and/or hardware resources for vCore instances, including for example: CPU Cores, memory, VFs, MAC addresses, etc. The RAM 520 may also provide server configuration, including OS configuration, driver support, etc., diagnostics and health monitoring. The COTS Server and/or “bare metal” server and/or virtual machine and/or other server may include an orchestration app 540 that manages, at least in part, the management of the vCores (e.g., containers and/or pods).

The COTS Server and/or “bare metal” server and/or virtual machine and/or other server may run the PTP application 522 that synchronizes the system clock of the COTS Server and/or “bare metal” server and/or virtual machine and/or vCore instances 520 based upon a grand master clock for the system as a whole. For increased accuracy, the PTP application 522 is preferably based upon hardware time stamping and a Precise Hardware Clock that is present on the NICs 514.

The container initialization and resource allocation for the containers may be performed in a distributed fashion. An initial vCore initialization 582 may be used to perform, or otherwise cause to be performed, a default configuration of an instantiated vCore. A vCore orchestration 584 may be used to perform, or otherwise cause to be performed, a management of the instantiated vCores together with allocation of resources for particular vCores. In this manner, the initial vCore initialization 582 and the vCore orchestration 584 work together to instantiate vCores, allocate resources to vCores, and manage the resourced instantiated vCores. The initial vCore initialization 582 preferably operates in conjunction with the orchestration app 540 on the server to instantiate the default vCores. The vCore orchestration 584 preferably operates in conjunction with the orchestration app 540 on the server to perform the orchestration of the vCores. The vCore orchestration 584 preferably operates in conjunction with the RAM 520 to allocate recourses for the vCores.

As noted previously, the COTS server that includes vCore instances has allocation of resources that are managed, at least in part, by the RAM 520. During the COTS server startup phase the RAM may create multiple resource pools (CPU Cores, data plane network VFs, encryption VFs, etc.), after which the RAM may assign or lease resources from each pool to vCore PODs upon deployment as requested by the container orchestration system 540. In addition, the RAM 520 may manage data encryption and decryption that may be selectively off loaded to dedicated hardware, as desired.

The RAM 520 may include a REST API that may be used to assign and free up resources, and which may also be used to determine resource availability and allocation status. The RAM 520 may also checkpoint periodically the resource pools status to an in-memory key-value database cache with durability and use that cached data in the event of a COTS server crash. The in-memory key-value database cache is preferably unsuitable for readily random access and is more suitable for reconstruction of the data back into memory in the event that the COTS server crashes.

A vCore instance configuration is typically composed of at least two parts. The first part may be the RPHY Mac Core configuration. The RPHY Mac Core configuration includes, for example, the DOCSIS, RF, RPD, cable-mac, IP addressing, routing, etc. The second part may be the data plane configuration 532. The data plane configuration 532 and in particular a virtualized data plane for RPHY MAC Core devices configuration includes, for example, CPU Core Ids that are used by the data plane 532, data plane network VF addresses that are used by the data plane 432, MAC addresses for the interfaces, encryption VFs addresses that are used for encryption offload, memory allocation, etc. In many embodiments, the RPHY Mac Core configuration is provided by the multiple system operators prior to actual configuration. The vCore instance of the data plane 532 may be determined based upon the resource information received from the RAM 520 by the vCore instance itself during the initialization phase. As a general matter, the vCore preferably performs the MAC layer functionality.

As previously described, a vCore is, in general, a software implementation of a CMTS core which includes data plane functionality that routes data packets between the public Internet and consumer premises equipment. The ability of a vCore to provide CMTS services is a function of the capabilities of the underlying hardware, which is typically a COTS server. Such COTS servers maintained within a data center typically include one or more processors, each of which normally includes an integrated plurality of cores (e.g., 4, 8, 16, 20, or more). In general, each core of each processor may be considered as its own computing system in that it has its own instruction pipeline, decoder, stack, and available memory. A software program that is decomposable into smaller parallel processing chunks may be substantially accelerated by scheduling the independent processing chunks to different cores of a multi-core processor and executing the independent processing chunks in at least a partial parallel manner. For example, a set of 10 independent functions can be split onto 10 cores and, if each function takes the equivalent time to complete, will execute generally 10 times faster than running all the 10 independent functions on a single core of a single core processor or on a single core of a multi-core processor. Accordingly, decomposing a software program into sub-programs and scheduling the sub-programs to be executed simultaneously on multiple cores of a processor provides acceleration of the processing and increases the efficiency of the hardware in terms of running more instructions per second when considering all the cores within the processor.

For a vCore, it is often desirable to reserve at least one of the cores for selective compute intensive operations, such as real-time data plane packet processing to maximize the performance throughput of the data packets.

Depending on the computing resources likely necessary for a set of one or more service groups, it is desirable to provide a vCore with sufficient computing resources to provide effective and timely processing. By way of example, allocating too few cores and/or vNIC bandwidth to a vCore will starve the service of resources, resulting in a reduced quality of service to customers. Also, depending on the computing resources likely necessary for a set of one or more service groups, it is desirable to provide a vCore without excessive computing resources to provide effective and timely processing. By way of example, allocating too many cores and/or reserving too much vNIC bandwidth to a vCore will not utilize the overall COTS server hardware efficiently leaving unused capabilities on the COTS server. Appropriate selection of one or more cores and/or vNIC bandwidth for a vCore is desirable. Further, it is desirable to efficiently install and configure vCores to allocate appropriate resources.

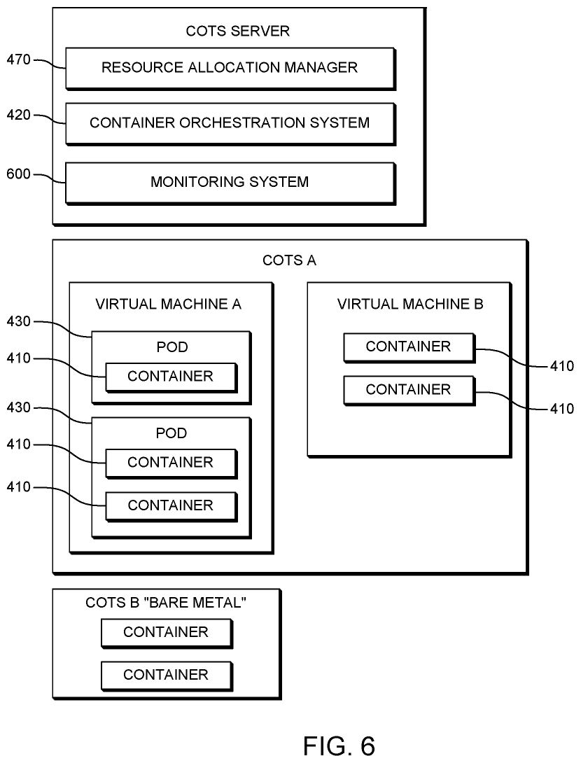

Referring to FIG. 6, in some implementations to provide known processing capabilities each of the vCores is instantiated to include the same processing capabilities. Alternatively, different vCores may have different processing capabilities. A monitoring system 600 may monitor the activities of each of the vCores that are operating on one or more COTS servers and/or “bare metal” servers and/or virtual machines and/or software containers. The monitoring system 600 may monitor the usage of the servers, vCores, and remote physical devices. Upon detection of excessive and/or unbalanced usage of one or more of the servers, the vCores, and/or the remote physical devices by the monitoring system 600, one or more of the remote physical devices may be interconnected with a different vCore. The different vCore for the remote physical device may be on the same host as the current vCore or may be on a different host than the current vCore. The different vCore may be a new vCore, on the same or a different host, or an existing vCore currently providing data to other existing remote physical devices, on the same or a different host.

In the event of a newly instantiated vCore, it is instantiated as a new software application which is booted and loaded with a configuration file describing the environment, such as for example, the RPHY Mac Core configuration and the data plane configuration. The newly instantiated vCore then connects with the moved one or more remote physical devices and thereafter operates in the same manner prior to moving the one or more remote physical devices.

In the event of a previously existing vCore, it may be loaded with a configuration file describing the environment, such as for example, the RPHY Mac Core configuration and the data plane configuration. The previously existing vCore then connects with the moved one or more remote physical devices and thereafter operates in the same manner prior to moving the one or more remote physical devices. In this case, the previously existing vCore is providing services to one or more additional remote physical devices.

The monitoring system 600 may also monitor the activities of one or more COTS servers and/or “bare metal” servers and/or virtual machines. The monitoring system 600 may detect when one or more of the COTS servers and/or “bare metal” servers and/or virtual machines has excessive and/or unbalanced usage. Upon detection of the excessive and/or unbalanced usage of one or more of the COTS servers and/or “bare metal” servers and/or virtual machines, such as excessive microprocessor usage and/or data transfers by the monitoring system 600, one or more of the remote physical devices associated therewith may be interconnected with vCores on a different host. The different host may be an existing host that includes vCores associated with remote physical device(s), an existing host with newly instantiated vCore(s), or may be a newly instantiated host with newly instantiated vCore(s).

In the event of a newly instantiated host, it is powered up and one or more vCores are instantiated to boot the software and loaded with a configuration file describing the environment, such as for example, the RPHY Mac Core configuration and the data plane configuration. The newly instantiated host together with one or more vCores then connects with the moved one or more remote physical devices and thereafter operates in the same manner prior to moving the one or more remote physical devices.

In the event of a previously existing host that includes one or more vCores or a newly instantiated vCore(s), the one or more existing vCores or newly instantiated vCores may be loaded with a configuration file describing the environment, such as for example, the RPHY Mac Core configuration and the data plane configuration. The previously existing host together with the one or more vCores then connects with the moved one or more remote physical devices and thereafter operates in the same manner prior to moving the one or more remote physical devices. In this case, the previously existing vCores may be providing services to one or more additional remote physical devices.

To move an existing remote physical device from a source vCore to a destination vCore, the destination vCore should be instantiated with operational software operating thereon, if needed. In the case that a new destination host needs to be used, it should likewise be powered up and the destination vCore should be instantiated with operational software operating thereon. Depending on the particular environment, a portion of the configuration describing the environment may be loaded onto the destination vCore, such as for example, the RPHY Mac Core configuration (e.g., the DOCSIS, RF, RPD, cable-mac, IP addressing, routing, etc.) and the data plane configuration (e.g., the CPU Core Ids that are used by the data plane, data plane network VF addresses that are used by the data plane, MAC addresses for the interfaces, encryption VFs addresses that are used for encryption offload, memory allocation, etc.).

A memory structure may also checkpoint periodically the state of each vCore to an in-memory key-value database cache with durability and use that cached data in the event of using a new destination COTS server together with destination vCores for the movement of a remote physical device, or otherwise the movement of a remote physical device to a destination vCore on the same server. The data may be stored in a database on a storage device, such as a hard drive. Preferably, the database is maintained on a COTS server (e.g., computing device), that is different than the computing devices maintaining the vCores. In this manner, if the computing devices supporting the vCores fail, the database will still be available. A key may be used to access the in-memory key-value database cache, which is provided to the replacement vCore and/or computing device (e.g., server or otherwise) so that it may access the data in the cache.

Another type of data that should be periodically checkpointed is sequence numbers being used by each of the vCores. The reliable delivery of data (messages) is a purpose of a L2TP control channel. The L2TP includes sequence numbers that specify a message. The L2TP may include a packet structure that includes (1) flags and version, (2) length (optional), (3) Session ID, (4) Ns (optional), (5) Nr (optional), (6) offset size (optional), (7) offset pad (optional), (8) and payload data. In particular Ns is a sequence number for a data or control message, beginning at zero and incrementing by one (modulo 2¹⁶) for each message sent, and is present only when sequence flag set. In particular Nr is a sequence number for expected message to be received, where Nr is set to the Ns of the last in-order message received plus one (modulo 2¹⁶). With the sequence number(s) being available, the destination vCore may be able to avoid the need to reconfigure the channel, which is a substantial time for a service impact to the customers. Accordingly, the checkpointing should include the sequence number(s) of the L2TP (layer 2 tunneling protocol). L2TP is described in IETF (1999), RFC 2661, Layer Two Tunneling Protocol “L2TP”, incorporated by reference herein in its entirety. Other portions of the packet structure may likewise be included, as desired.

The checkpointing may also include the state for all of the components on the network, such as for example, remote physical devices, cable modems, consumer premise equipment, DHCP, routing/address resolution protocol data, etc. By way of example, the state may include, off-line, on-line, DHCP address, RF status, booting, cable source verify (verifies 1 mac address is tied to a single IP address), etc.

In the case of a distributed access architecture, it is desirable to checkpoint selected additional system level configuration data. The system level configuration data may include log information from the existing servers, current vCores, and/or current remote physical devices. The system level configuration data may include alarm related information, such as timing of the current vCores failing, failed vCores starting, and error messaging between the vCores and the associated remote physical devices. The system level configuration data may include a network element inventory, such as identification (e.g., by name and/or IP address) of each of the remote physical devices associated with each vCore, configuration parameters of each of the remote physical devices associated with each vCore, and the configuration parameters of each vCore related to the remote physical devices. The system level configuration data is preferably checkpointed on a periodic basis for configuring a destination server and/or destination vCores.

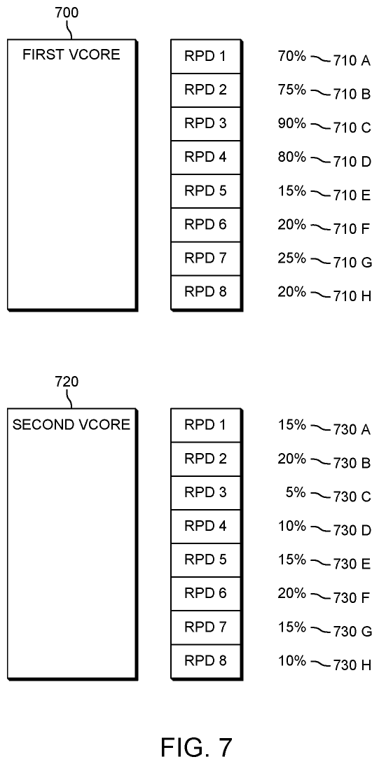

Referring to FIG. 7, a first vCore 700 is illustrated that supports eight remote physical devices 710A, 710B, 710C, 710D, 710E, 710F, 710G, and 710H. It is to be understood that a vCore may support any suitable number of remote physical devices. The remote physical devices 710A-710H each have different average usage, such as 710A-710D having a heavy usage and 710E-710H having a light usage. A second vCore 720 is illustrated that supports eight remote physical devices 730A, 730B, 730C, 730D, 730E, 730F, 730G, and 730H. The remote physical devices 730A-730H have light usage. In the case that the first vCore 700 and the second vCore 720 are both supported by the same host, it may be desirable to move some of the heavily used remote physical devices 710A-710D to the second vCore 720, or otherwise exchange some of the heavily used remote physical device 710A-710D for some of the lightly used remote physical device 730A-730H, so that the usage of the first vCore 700 and the second vCore 720 are more balanced. The balancing of the loads on the vCores assists with accommodating spikes in future usage and thereby reduces the error rate. In addition, the processing latency through a vCore may depend on the loading. Balancing of the loads on the vCore helps reduce the latency of certain service groups (RPDs) in comparison to others. In the case that the first vCore 700 and the second vCore 720 are each supported by different hosts, it may be desirable to move some of the heavily used remote physical devices 710A-710D to the second vCore 720, or otherwise exchange some of the heavily used remote physical device 710A-710D for some of the lightly used remote physical device 730A-730H, so that the usage of the host serving the first vCore 700 and the host serving the second vCore 720 are more balanced. The balancing of the loads on the servers assists with accommodating spikes in future usage and thereby reduces the error rate.

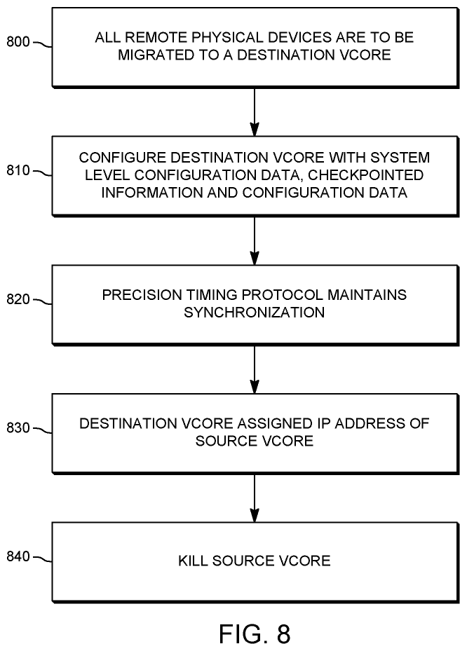

Referring to FIG. 8, in one embodiment the monitoring system 600 determines that all remote physical device associated with a source vCore should be moved to a destination vCore 800, which may occur as a result of (1) moving the remote physical devices of the source vCore on a source host to the destination vCore on a destination host or (2) may occur as a result of moving the remote physical devices of the source vCore on the source host to the destination vCore on the source host. The destination vCore preferably does not have other remote physical devices associated therewith. The destination vCore is configured to include the system level configuration data, checkpointed information, and/or configuration data 810. During the migration process the precision timing protocol timing between the destination vCore and the remote physical devices maintains their synchronization 820 because the destination vCore is assigned the IP address of the source server and/or vCore 830. In some cases, the precision timing protocol synchronization may be lost for a limited duration. In this manner, the remote physical devices will not need to enter into a resynchronization process, or otherwise a rebooting process, nor request the IP address of the destination server from the dynamic host configuration protocol server. The remote physical devices remain synchronized with the destination vCores. Also, cable modems maintain their interconnection with the remote physical devices, and therefore avoid performing a registration process with the vCore. This movement process occurs, generally in parallel, for each of the remote physical devices associated with the migration. This process may be completed with no, or insubstantial, interruption of service to the customers. The IP address of the source vCore is modified or otherwise the source vCore is “killed” 840. As discussed above, the migration process maintains the precision timing protocol as a result of the destination vCore taking on the IP address of the source vCore. Also, typically a series of switches and/or routers between the host and the remote physical devices are updated to provide the routing to the destination vCore rather than the source vCore.

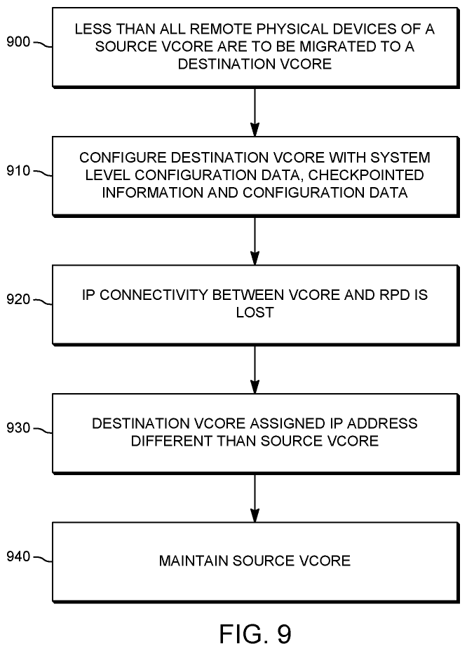

Referring to FIG. 9, in another embodiment the monitoring system 600 determines that less than all remote physical device associated with a source vCore should be moved to a destination vCore 900, which (1) may occur as a result of moving some of the remote physical devices of the source vCore on a source host to the destination vCore on a destination host or (2) may occur as a result of moving some of the remote physical devices of the source vCore on the source host to the destination vCore on the source host. The destination vCore preferably does not have other remote physical devices associated therewith. Alternatively, the destination vCore may have other remote physical devices associated therewith. The destination vCore is configured to include the system level configuration data, checkpointed information, and/or configuration data 910. In many cases, the state information is not necessary since many of the connections are likely going to be restarted. During the migration process the IP connectivity between the destination vCore and the remote physical devices is lost 920 because the destination is provided with a new IP address that is different than that of the source server and/or vCore 930. The new IP address is used because the source vCore maintains its IP address for the remaining remote physical devices associated with the source vCore. In this manner, the remote physical devices may enter into a resynchronization process, or otherwise a rebooting process, and request the IP address of the designated vCore from the dynamic host configuration protocol server or otherwise provided with the IP address. This process occurs, generally in parallel, for each of the remote physical devices associated with the migration. This process may be completed with some interruption of service to the customers. The IP address of the source vCore is not modified or otherwise, and the first vCore is not “killed” 940. Also, typically a series of switches and/or routers between the host and the remote physical devices are updated to provide the routing to the destination vCore rather than the source vCore for selected remote physical devices.

In another embodiment, the remote physical device may have its precision time protocol timing synchronized with a root timing reference, generally referred to as a grandmaster. The grandmaster transmits synchronized information to the clocks residing on its network segment which may use boundary clocks to other network segments. The source vCore may have its precision time protocol timing synchronized with the same root timing reference, generally referred to as the grandmaster. The destination vCore may have its precision time protocol timing synchronized with the same root timing reference, generally referred to as the grandmaster. In this manner, the source vCore, destination vCore, and the remote physical device are all synchronized to the same root timing reference. In this case, the remote physical device may, in some cases, omit a complete rebooting process or otherwise the time consuming process of restabilising the synchronization with the root timing reference.

In another embodiment, each of the vCores may include a primary or real IP address that is bound to its interface card and/or may likewise include a plurality of virtual IP addresses. In this manner, each of the vCores may be associated with a virtual IP address that is used for interconnection with each of the associated remote physical devices. When all the remote physical devices associated with a source vCore on the source server are moved to a destination vCore on the source server, or all the remote physical devices associated with the source vCore are moved to a destination vCore on a destination server, the virtual IP address may be maintained so that resynchronization may be avoided or otherwise reduced.

In another embodiment, each of the vCores may include a primary or real IP address that is bound to its interface card and/or may likewise include a plurality of virtual IP addresses. Each of the remote physical devices may be associated with a corresponding one of the virtual IP addresses. In this manner, each virtual IP address only provides an interconnection between the vCore and one remote physical device. In this manner, each of the remote physical devices may be associated with a unique virtual IP address that is used for interconnection with the associated vCore. When all or a portion of the remote physical devices associated with a source vCore on the source server are moved to a destination vCore on the source server, or all or a portion of the remote physical devices associated with the source vCore are moved to a destination vCore on a destination server, the virtual IP address associated with the vCore for each of the remote physical devices may be maintained so that resynchronization may be avoided or otherwise reduced. Such a move of the maintained virtual IP address can be accomplished with dynamic routing protocol such as BGP. Such a BGP routing advertisement change can be externally triggered by the monitoring system along with loading all RPD related state information to the destination vCore. Alternatively, the routing change can be made automatic by both source vCore and destination vCore instances advertising the same virtual IP address with a different metric. When the lower metric advertisement from the source vCore instance ceased or deleted then all packets will be forwarded to destination vCore instance. In this case, the monitoring system could peer with the BGP route reflectors to understand such BGP routing advertisement changes and trigger loading all RPD related state information to the destination vCore accordingly.

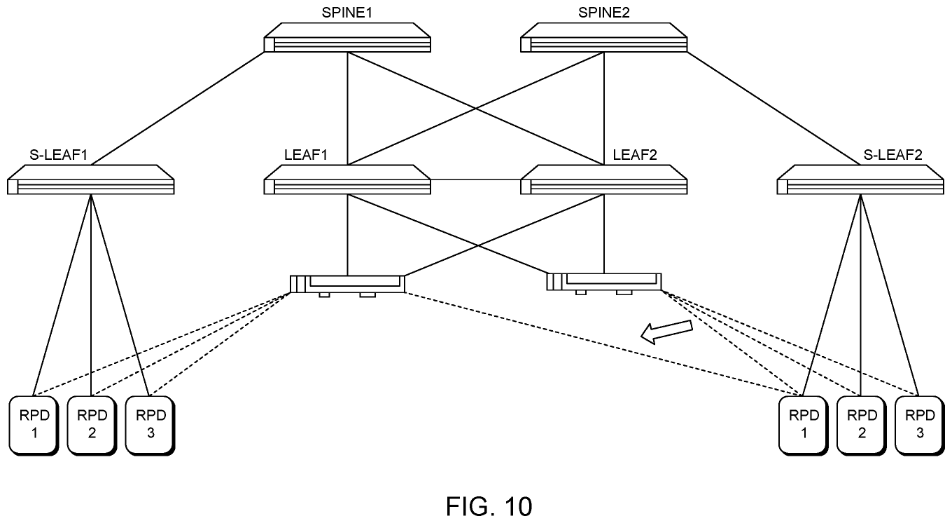

Referring to FIG. 10, the dynamic remote physical device reallocation is illustrated together with a set of leaf switches and spline switches. In this example, the remote physical device 1 (RPD 1) is moved from a vCore on a source server to a vCore on a destination server, as indicated by the arrow. In another embodiment, when a source vCore on a source server is moved to a destination vCore on the same source server, the next-hop switch should be instructed to send the packets destined for the source vCore to the destination vCore. Assuming the case that the destination vCore assumes the IP address of the source vCore, the destination vCore sends a gratuitous address resolution protocol to the next-hop switch which provides this information to the switch. In another embodiment, when a source vCore on a source server is moved to a destination vCore on a different destination server and the IP address of the destination vCore is either same different from the source vCore, the next-hop switches should be instructed to send the packets destined for source vCore to the destination vCore. This can be accomplished by routing protocols like BGP on the vCore. Using BGP protocols, the destination vCore announces its IP address, IP addresses of the Mac Domain, etc. Using the BGP protocol, the next-hop switch and any other switching fabric in the network learns the addresses of the destination vCore.

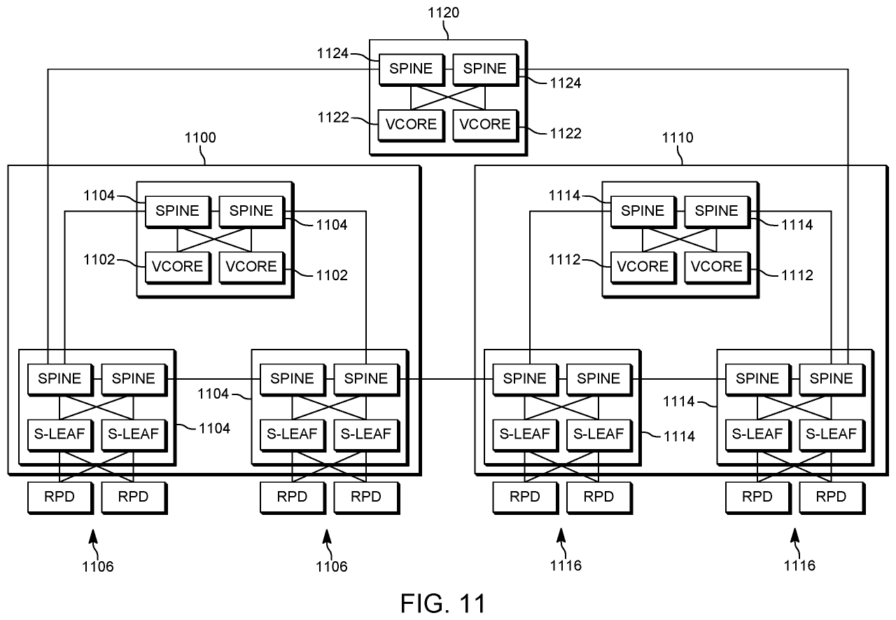

Referring to FIG. 11, the dynamic remote physical device reallocation may be used for capacity augmentation for servers and/or vCores providing services to remote physical devices. A first server 1100 that includes a plurality of vCores 1102 and a plurality of switches 1104 provides services to a plurality of remote physical devices 1106. A second server 1110 that includes a plurality of vCores 1112 and a plurality of switches 1114 provides services to a plurality of remote physical devices 1116. The first server 1100 and the second server 1110 may be remotely located from one another, such as separated by 100 kilometres or more. An augmentation server 1120 includes a plurality of vCores 1122 and a plurality of switches 1124 that is configurable to provide services to a plurality of remote physical devices. The augmentation server 1120 may be configured, on demand, to provide services to one or more of the remote physical devices 1106, 1116. In this manner, the load on the either the first server 1100 or the second server 1110 may be reduced. In some cases, based upon load predictions, the movement of remote physical devices from the first server 1100 and/or the second server 1110 may be automatically moved to accommodate differences in usage patterns.

The server (COTS server and/or “bare metal” server) may include one or more processors fabricated as an integrated circuit. Each processor is composed of a plurality of separate processing units generally referred to as cores, each of which reads and executes program instructions. Each processor can run instructions on the separate cores at the same time, thereby increasing the overall speed for programs that support multithreading or other parallel computing. To further increase performance, in some processor architectures for each core that is physically present two virtual (i.e., logical) cores may be used. In this manner, concurrent scheduling of the two processes for each logical core may be used. Typically, the virtual cores are achieved by duplication of portions of the processor, those that store the architectural state, but not duplicating the main execution resources.

Due to the real time constraints, the vCores are preferably implemented such that each vCore is assigned its own cores that it doesn't share with other vCores. A vCore supports downstream traffic to consumer premise equipment and supports upstream traffic to the Internet. To ensure that the downstream traffic and the upstream traffic do not result in interfering with the ability to process data in a timely manner, each vCore preferably uses a first core for the upstream traffic and a second core for the downstream traffic. In this manner, the upstream traffic and downstream traffic are effectively isolated from one another. Also, preferably no other processes from other software programs share the cores being used by the vCore for dataplane services. For reference purposes, this vCore configuration may be referred to as a 1-1 vCore (1 core upstream for dataplane services and 1 core downstream for dataplane services). More preferably, the vCore uses logical cores, so that a 1-1 vCore may be supported by a single core. By way of example, a single processor may have 30 physical cores and 60 logical cores. With a vCore using 2 logical cores, the single processor can support up to 30 1-1 vCores.

After consideration of the typical usage by consumer premise equipment, it was determined that the vCore provides more processing and data for the downstream traffic (i.e., the downstream core for dataplane services) than for the upstream traffic (i.e., the upstream core for dataplane services). In this case, the logical core associated with the vCore's upstream data traffic for dataplane services is being underutilized. To accommodate a more balanced usage of the logical cores, the vCore preferably uses a first core for the upstream traffic for dataplane services, and a second and third cores for the downstream traffic for dataplane services. In this manner, the upstream traffic for dataplane services and downstream traffic for dataplane services are effectively isolated from one another. Also, preferably no other processes from other software programs share the cores being used by the vCore for dataplane services. For reference purposes, this vCore configuration may be referred to as a 1-2 vCore (1 core upstream for dataplane services and 2 cores downstream for dataplane services). More preferably, the vCore uses logical cores, so that a 1-2 vCore may be supported on one and a half cores. By way of example, a single processor may have 30 physical cores and 60 logical cores. With a vCore using 3 logical cores, the single processor can support up to 20 1-2 vCores. Also, the 1-2 vCores are suitable to support a larger number of subscribers than a 1-1 vCore, while making better utilization of the processing capabilities of the processor.

Each of the vCores may use any suitable number of cores for the upstream data traffic for dataplane services and any suitable number of cores for the downstream data traffic for dataplane services. Preferably, the number of cores for the upstream data traffic for dataplane services of a vCore is less than or equal to the number of cores for the downstream data traffic for dataplane services.

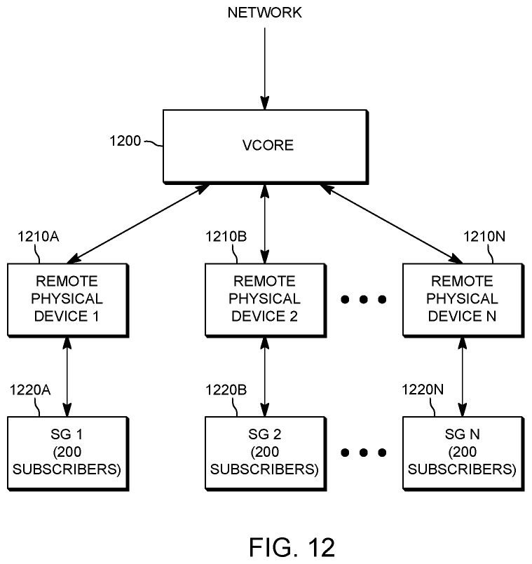

Referring to FIG. 12, a vCore 1200 may provide services to one or more remote physical devices (RPDs) 1210A, 1210B, . . . 1210N. Each of the remote physical devices (RPDs) 1210A, 1210B, . . . 1210N are associated with a corresponding service group 1220A, 1220B, . . . 1220N, which may provide services to a group of customer premises equipment. While a vCore may provide services to only a single remote physical device and the corresponding single service group, this tends to be an inefficient use of computing resources on the server because of the instantiation and management of a substantial number of vCores, each of which consumes a substantial amount of resources. Also, the vCore may have the capacity to process a substantial amount of data but the associated RPD may only be currently providing services for a limited amount of data, and in this manner there is often a substantial unused amount of capacity for the associated vCore. Further, the vCore may have the capacity to process a substantial amount of data but the associated RPD may be currently providing services for an even greater amount of data, and in this manner there may be insufficient capacity for the associated vCore. In contrast to a one-to-one correspondence between the vCore, the remote physical device, and the service group, it is desirable to have a one-to-many correspondence between the vCore, a set of remote physical devices, and a set of service groups. Preferably, a defined set of cores and/or logical cores are used by the vCore to provide services for the set of remote physical devices.

Over time each of the service groups 1220A-1220N may have different usage patterns, such that during particular times of the day, the week, the month, or the year the usage tends to vary in some manner. In some cases, each of the service groups 1220A-1220N may have different usage patterns that may be predictable, and in other cases the different usage patterns may not be predictable. Typically, on an annual basis the usage for each of the service groups tends to increase. Also, the collection of the service groups 1220A-1220N as a whole may have variable usage patterns, such that during particular times of the day, the week, the month, or the year that tends to vary in some manner. In some cases, the collection of service groups 1220A-1220N as a whole may have usage patterns that may be predictable, and in other cases the usage patterns are not predictable. Typically, on an annual basis the usage for each of the collection of service groups tends to increase.

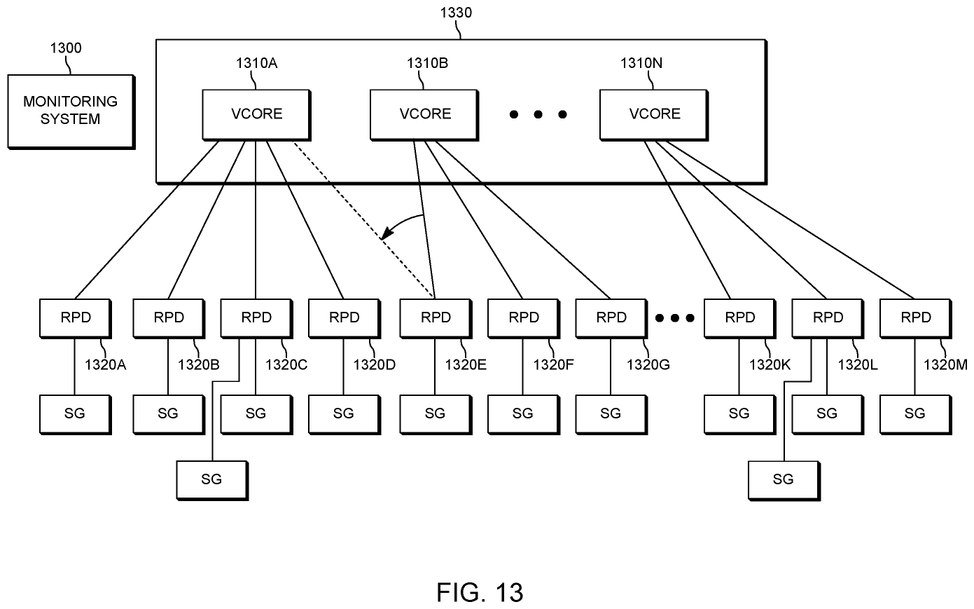

Referring to FIG. 13, a monitoring system 1300 may be used to manage a distribution of remote physical devices 1320A-1320M among a set of associated vCores 1310A-1310N. Each of the RPDs may provide data to and receive data from one or more service groups. The service groups may support any suitable number of customer devices. The associated vCores may be supported by one or more servers 1330. The monitoring system 1300 may be included on the one or more servers 1330 or otherwise on a computing device apart from the one or more servers 1330. The monitoring system 1300 may determine the utilization of each of the vCores 1310A-1310N, to determine those that have substantial unused capacity, or those that are more likely to exceed their capacity or otherwise have exceeded their capacity. Also, based upon usage patterns, the monitoring system 1300 may proactively estimate the anticipated future usage of each of the vCores and groups of vCores. The monitoring system 1300 may similarly determine the utilization of each of the remote physical devices 1320A-1320M to determine the capacity being used by each of the remote physical devices.

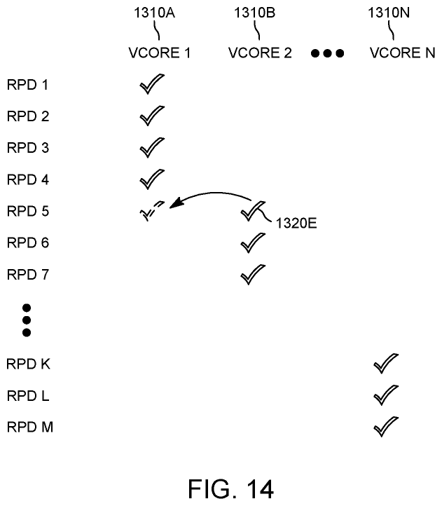

Referring to FIG. 14, the monitoring system may automatically or as a result of a user initiated selection reassign a particular remote physical device (e.g., RPD 1320E), including the associated service group(s), from a source vCore (e.g., 1310B) to a destination vCore (e.g., 1310A). In this manner, the usage for vCore 1310A is increased while the usage for vCore 1310B is decreased, which may be based upon available resources.

While the management of the RPDs among the vCores is beneficial, the management and distribution of the RPDs among the vCores may be based upon the available bandwidth for each of the RPDs and/or the vCores. Each of the servers may have one or more network interface cards (e.g., DP NIC1(PF) and DP NIC2(PF) 514, see FIG. 5). By way of example, a server may have a pair of network interface cards that each include a dual port 100 GB PCIe Ethernet connection. Each of the vCores on a respective server may be assigned a virtual network function for each of the ports of one or more network interface cards (e.g., VFn 534, see FIG. 5). In this manner, the physical network bandwidth of the server is allocated among a plurality of virtual network functions for a plurality of vCores. By way of example, with 10 vCores instantiated on the server, each of the vCores may be allocated 10 GB of network bandwidth for each of the network cards. Moreover, each of the vCores may be allocated a different amount of bandwidth, if desired.

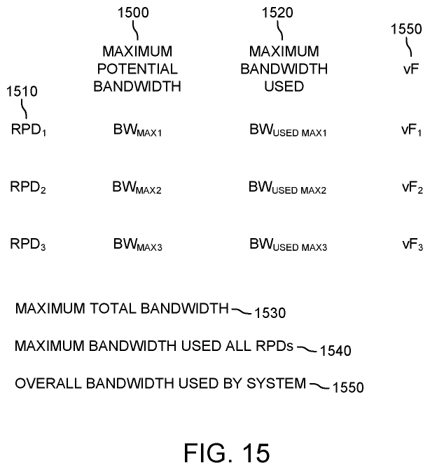

Referring to FIG. 15, the monitoring system 1300 may estimate the maximum potential bandwidth BWₘₐₓ 1500 for the total number of customers associated with respective service groups for each of the remote physical devices 1510. This estimation may be the highest bandwidth that may be provided to each remote physical device if all the respective customers were simultaneously using their maximum allocated bandwidth or otherwise the capability of the RPD, otherwise the estimation may be based upon a statistical model using average and highest bandwidth of all of the subscribers, or otherwise based upon any other suitable criteria or statistical measure. Also, depending on the bandwidth allocation to the customers associated with a respective service group, the maximum allocated bandwidth may be limited by the remote physical device's capability. However, in practice this maximum bandwidth for each remote physical device is rarely, if ever, reached so the system preferably tracks the maximum bandwidth used (BW_{used_maximum}) 1520 over time by the customers associated with a particular remote physical device. In addition, the monitoring system 1300 may estimate the maximum total bandwidth 1530 provided if all the customers for all associated remote physical devices of a particular vCore were simultaneously using their maximum allocated bandwidth. Also, depending on the bandwidth allocation to the customers associated with the respective service groups, the maximum total bandwidth may be limited by the maximum bandwidth of the remote physical devices. However, in practice this maximum bandwidth is rarely, if ever, reached so the system preferably tracks the maximum bandwidth used over time by all the customers associated with all the remote physical devices 1540.

The monitoring system 1300 may compare the maximum bandwidth and/or estimated maximum bandwidth used by a particular vCore to the allocation of the virtual bandwidth vF 1550 for that particular vCore. In most situations, preferably the particular vCore only uses a fraction, such as no more than 75%, of the maximum potential bandwidth 1500 of the particular vCore to provide headroom in the event of additional spiked bandwidth is used at any particular point in time. In the event that the usage of any particular vCore becomes too close to the virtual bandwidth that is allocated to a particular vCore, then one or more remote physical devices 1510 may be reallocated from the current (e.g., source) vCore to another vCore that has available unallocated bandwidth.

By way of example, the monitoring system 1300 may monitor the deployment of an additional vCore on a particular server. The monitoring system 1300 may further estimate the bandwidth to be used or otherwise being used by the additional deployed vCore by the associated remote physical device(s) and associated service group(s) in comparison to its associated vF so that excess data traffic is not associated with the newly additional deployed vCore.

The monitoring system may also monitor the overall bandwidth being used by all of the vCores inclusive of any system services 1550, such as using a monitoring system included within the underlying operating system, to monitor the overall usage for the physical network interface card(s). In this manner, the system may determine whether the server as a whole is being overloaded or otherwise ensure sufficient headroom is being maintained. At such a time that the overall bandwidth being used by the server is sufficiently high, no additional vCores are preferably instantiated on the server and existing remote physical device(s) may be reallocated to a different server with available unallocated bandwidth.

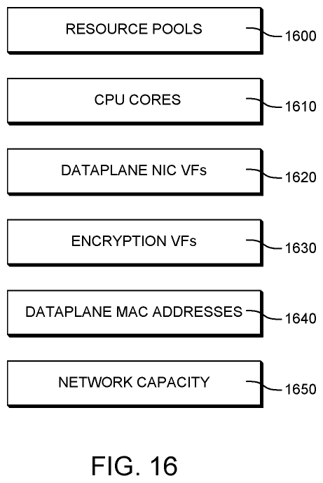

Referring also to FIG. 16, the RAM 520 resource pools 1600 may include, for example, several hardware and/or software resources that may be allocated.

One resource pool may include CPU Cores 1610. From the total number of physical CPU cores available on a server (Tc), the COTS server bootup configuration may assign several operating system scheduled CPU cores (Sc) and a number of isolated CPU cores (Ic), with Sc+Ic=Tc. The Sc CPU cores are used by non-data plane applications (OS, RM, PTP App, Control Plane and Management Plane, etc.), while the Ic CPU Cores are used exclusively by the data plane based software. The RAM may create and manage the CPU Core pool 1610 composed of Ic cores, identified by CPU Core Id.

Another resource pool may include data plane NIC VFs 1620. Upon startup of the COTS server, with vCore instances, may create the data plane NIC VFs. The number of data plane NIC VFs created should be larger than the projected number of vCore instances that are likely to be deployed on the COTS server. The data plane NIC VF pool 1620 may include the PCI addresses, or otherwise, of all the data plane NIC VFs created upon startup.

Another resource pool may include encryption VFs 1630. In a manner similar to the data plane NIC VFs 1620, upon server startup encryption VFs may be created based upon a dedicated portion of an encryption device available to the vCore instance. The encryption VFs pool 1630 may include the PCI addresses, or otherwise, of all the encryption VFs created upon startup.

Another resource pool may include data plane MAC Addresses 1640. In many cases, the NIC VFs 534 receive “random” MAC addresses assigned via the operating system Kernel or drivers in the data plane 532. Using “randomized” MAC addresses for vCore instances is not optimal and requires complicated MAC address management. The data plane MAC address pool 640 may use Locally Administered Ranges (e.g., a local area network) that are unique for each server for vCore instances.

Another resource pool may include network capacity 1650. SR-IOV does not support bandwidth partitioning which results in the PF or the VF on a data plane NIC being capable of using some or all the bandwidth available on that NIC at any given point in time. Providing bandwidth partitioning of the network capacity may be performed as follows. The system may assume a data plane NIC on a particular server with vCore instances has a total bandwidth of Tbw, and each vCore instance deployed on that server requires some capacity calculated based on the above mentioned formula (Cbw=f₂ (USsg, DSsg)), then the sum of capacity needed by all vCore instances deployed on the COTS server is less than total available bandwidth (Cbw1+Cbw2+ . . . +CbwN<Tbw). Thus, the Network Capacity “pool” 1650 may be the total bandwidth available (Tbw) on a data plane NIC. The RAM 520 may then reserve network capacity for a vCore instance upon request up to Tbw.

Other resource pools may likewise be included, as desired.

Network traffic planning may be used to characterize the bandwidth resources that are likely required to service a set of customers. The network traffic planning may be used to represent the desired bandwidth based upon a relationship using the parameters of Tmax and Tavg, which represent the maximum available bandwidth service (“billboard bandwidth”) and the real average bandwidth (e.g., any statistical measure) usage over all customers, respectively. Tmax and Tavg tend to change over extended periods of time but are relatively constant at any specific point in time. Moreover, Tmax and Tavg historically tend to be monotonically increasing over increasingly extended periods of time and may be predictably estimated over future periods of time using growth estimates derived from previous periods of time. The rate of growth of Tmax and Tavg is relatively constant over increasingly extended periods of time.

Another parameter useful to characterize the bandwidth resources that are desired to service a set of customers is the number of customers (i.e., Nsubs) for which the network associated with a vCore will provide services for. The number of customers multiplied by the average bandwidth usage provides a nominal average usage across all customers. While this number by itself is useful to understand a nominal bandwidth usage it does not include additional headroom that may be desired to accommodate bursts of traffic above the average usage. The Tmax parameter is a useful proxy for allocating additional headroom to accommodate bursts of traffic. The Tmax parameter may be further modified using a quality of service parameter, k, resulting in an overall traffic capacity that varies depending on the quality of service factor. One representation of this relationship is provided as:

Desired Capacity=Tavg*Nsubs+k*Tmax

When allocating a vCore for a group of customers, allocation of the set of computing resources is useful to efficiently use a COTS server. The network traffic planning relationship based on Nsubs, Tmax, k, and Tavg may be used to establish a preferred set of computing resources for providing the desired quality of service to the customers.

In addition to the system level parameters, other data center related characteristics may also be considered for resource allocation. COTS servers each have their own internal system clocks that control how many instructions per second a processor can process. The processors are often similar for COTS servers purchased at a point in time but tend to vary as technology changes over time. Data centers include COTS servers purchased at different points in time and therefore different COTS servers may have different operational characteristics related to the respective processing capacity. Other data center related characteristics may also be taken into consideration. For example, some COTS servers may include special hardware for processing cryptographic algorithms allowing them to provide greater overall throughput than a COTS server without such special hardware. For example, some COTS servers may include different amounts of memory associated with the processor(s) and/or cores of the processor(s). For example, some COTS servers may include different associated network interface cards, each of which has different interfacing capabilities. For example, some COTS servers may include hardware accelerators to increase the processing capabilities.

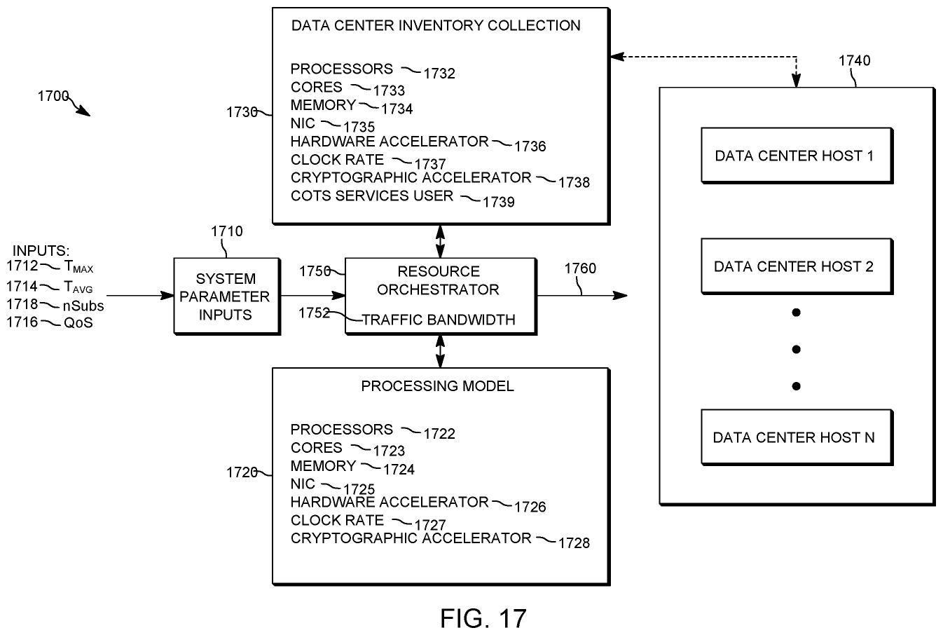

Referring to FIG. 17, exemplary elements that compose a resource deployment system 1700 for resource allocation for a vCore is illustrated.

The resource deployment system 1700 includes system parameter inputs 1710. The system parameter inputs 1710 may include, for example, Tmax 1712 (e.g., maximum available bandwidth), Tavg 1714 (e.g., real average bandwidth usage over all customers), QoS 1716 (e.g., quality of service), and Nsubs 1718 (e.g., number of subscribers/customers). A graphical user interface or other system may be used to provide and/or receive the system parameter inputs 1710 to the resource deployment system 1700.

The resource deployment system 1700 includes a processing model 1720. The processing model 1720 predicts the throughput of a vCore based upon one or more processors 1722 each having one or more cores 1723 with an associated processor clock rate 1727, memory associated with the processor(s) and/or cores of the processor(s) 1724, associated network interface card(s) 1725, and/or general hardware accelerators 1726. The processing model 1720 may also include estimates of throughput with or without cryptographic acceleration 1728.

The resource deployment system 1700 includes a data center inventory collection 1730. The data center inventory collection 1730 includes information on the COTS servers within one or more data centers that are available for hosting vCores. The data center inventory collection 1730 includes attributes of the available COTS servers including one or more processors 1732 each having one or more cores 1733 with an associated processor clock rate 1737, memory associated with the processor(s) and/or cores of the processor(s) 1734, associated network interface card(s) 1735, and/or general hardware accelerators 1736. The data center inventory collection 1730 may also include attributes of available cryptographic acceleration 1738.

The data center inventory collection 1730 also includes information on vCores and other computing services 1739 that are already operational on respective COTS servers and therefore already using computing resources and/or network interfaces on the respective COTS servers. The computing resources and/or network resources on the respective COTS servers that are not being consumed for vCore services, or other computing services, are available for deployment of additional vCore functions.

The resource deployment system 1700 includes one or more data center hosts 1740. The data center hosts 1740 represent COTS servers within one or more data centers that are available for placement of a vCore service thereon. Each data center host 1740 may have different characteristics which are known within the data center inventory collection 1730.

The system parameter inputs 1710, including for example, Tmax 1712, Tavg 1714, QoS (e.g., k) 1716, and Nsubs 1718, are provided to a resource orchestrator 1750. The resource orchestrator 1750 estimates the anticipated traffic bandwidth 1752 to accommodate the desired services. This anticipated traffic bandwidth may be estimated based on the input parameters as,

Desired Capacity=Tavg*Nsubs+k*Tmax.

The resource orchestrator 1750 obtains information related to available data center host 7140 resources from the data center inventory collection 1730. The list may include, for example, one or more of one or more core processors 1732 each having one or more cores 1733 with an associated processor clock rate 1737, memory associated with the processor(s) and/or cores of the processor(s) 1734, associated network interface card(s) 1735, general hardware accelerators 1736, attributes of available cryptographic acceleration 1738, and/or computing resources and/or network resources on the respective COTS servers that are not being consumed for vCore services, or other computing services that are available for deployment of additional vCore functions.

The resource orchestrator 1750 uses the traffic calculation (e.g., Desired Capacity=Tavg*Nsubs+k*Tmax) and information related available data center resources and invokes the processing model 1720 to estimate the appropriate number of computing resources to provide services for the desired vCore(s). The processing model 1720 may be constructed using measurements of traffic throughput for different COTS servers, each of which may have different characteristics. The processing model 1720 may use the information related available data center resources to determine which of the host resources have available sufficient resources to meet the estimated needs of the vCore services. The resource orchestrator 1750 based upon which host resources have available sufficient resources may primarily determine the number of processor cores and/or network bandwidth that would be reserved to deploy the vCore services to meet the desired system attributes and desired quality of service.

The resource orchestrator 1750 may determine, based on a suitable preference ordering technique, the preferred COTS server to deploy the vCore services and initiate the deployment of the vCore services 1760. At the initiation of the vCore deployment, the data center inventory collection 1730 is updated to reflect the reduction of available resources (e.g., processor core(s), vNIC bandwidth) for the target COTS server such that the resources are not overallocated to additional deployments.

Once deployed, the vCore is sized to use a preferred number of processor cores and/or vNIC bandwidth based upon the system traffic estimates and the selected COTS server. By way of example, the system parameter input, data center inventory collection resource orchestrator, and/or processing model may be combined together in whole or in part and may also be a portion of a larger resource deployment system. The resource deployment system may be operated on a computing device with a processor, which may include multiple computers and multiple processors, collectively considered a computing device and a processor. By way of example, the resource orchestrator may be further decomposed into an application controller that manages a set of software services that are deployed with a vCore and a cluster controller responsible for pulling software images, deploying the software images, and monitoring the software services within the COTS servers.

As previously discussed, the COTS servers represent computing resources for which a vCore services can execute. Before a vCore is initiated on a COTS server a determination is made whether a particular COTS server has the available resources for the vCore to function properly. As previously discussed, one of the available resources is whether the COTS server has the desired bandwidth estimated for the service group. The estimate for the desired bandwidth may be determined based upon the traffic engineering relationship previously discussed.

The resource orchestrator 1750 estimates the processing resources required to run specific components of vCore services. The resource orchestrator 1750 may use a processing model to take into account various factors that influence the resource estimation process. In one form of such an estimation model, a normalized reference point may be used to determine the computing resource requirements for the vCore services. For example, a reference point could provide the capacity of one processing core at a specific processor frequency. For example, a reference point could be as follows: 2500 Mbps at 2.4 GHz. In other words, a 2.4 GHz clocked processor of a COTS server may handle 2.5 Gbps traffic. In equation form this can be represented as:

TrafficCapacity=s*num_cores*clock_rate,
where s represents a bit-rate/clock-frequency scaling factor, num_cores is the number of cores, and clock_rate is the processor clock frequency. Solving for num_cores:

num_cores=TrafficCapacity/(s*clock_rate).

Using the reference point provides a reference value for s which may then be used to determine the preferred number of cores. Note that the number s may vary for each model of COTS server (e.g., different CPU, manufacturer, etc.) such that a table of s values are available for lookup. Because processor cores should only be allocated in integer increments (rather than allocating the same processor core to multiple different vCores), the resultant num_cores should be rounded up to the next integer. This technique provides a mechanism to estimate the preferred number of processor cores based on the anticipated traffic capacity and the processor clock rate. The traffic capacity and number of processor cores may represent the downstream traffic and/or upstream traffic. A similar estimation may be made to determine the number of cores required for the reciprocal traffic. It is noted that the s value may be different for the upstream and downstream cases since the processing chain is not identical. It is also noted that the s value may represent a vector of s values where each s value in the vector may be associated with different average network packet sizes. For example, s could be represented as s-small, s-med, and s-large where 250 byte, 750 byte, and 1250 byte average packet sizes are used respectively.

The difference between the rounded number of cores up to the next integer and the actual number of cores (e.g., including a partial processor core) prior to rounding up to the next integer represents the idle capacity of the processor cores in processing the network traffic. For increased efficiency of the overall COTS servers, this number is preferably small. A multi-step approach may be used in determining the “best fit” for a particular vCore service in a manner that minimizes the residual processing capability related to a particular set of processing cores for a Vcore. By way of example, the following process may be used to determine the “best fit”:
(1) List all servers that have sufficient network interface card bandwidth to meet the network traffic requirements.
(2) For servers meeting step (1), using the s values for each differing model of server, calculate the number of processor cores used to host the vCore services for each COTS server in the upstream direction and the downstream direction.
(3) Sum the integer number of processor cores for the upstream direction and the downstream direction for a particular vCore for each available COTS server. The COTS server with the smallest residual (rounded number of cores to the next greatest integer less actual number of cores) represents the “best fit” for the particular vCore service based on estimated processing load.
(4) If the data center contains multiple available COTS servers that would provide the “best match”, additional considerations may be used to select one of the “best match” COTS server. For example, it may be desirable to fill up the computing capacity of a particular COTS server before instantiating another similar COTS server.

The processing model may be expanded to further increase the accuracy of the processing estimate. By way of example, the processing model may be broken up into smaller tasks with specific characteristics needed to process traffic.

The reference point, as previously discussed, may be derived by measuring COTS server performance in a laboratory setting. The performance measurements may be based upon varying the data rates for a particular COTS server until the COTS server begins to drop packets. Alternatively, a more detailed technique to determine the reference point may use the major sub-tasks composing the data plane computational process. The more detailed technique may include one or more of the following factors: (1) various tasks in the vCore service, (2) hardware features such as the processor, cache, memory parameters, etc., of the COTS server, and (3) characteristics of the network traffic such as packet sizes, etc.

The vCore service may be broken up into various smaller tasks. An exemplary list of vCore tasks may include one or more of the following:
(1) Classification;
(2) Scheduling;
(3) IP look-up;
(4) Header re-write;
(5) AES/DES Encryption;
(6) AES/DES Decryption;
(7) DEPI Encapsulation; and
(8) DEPI Decapsulation.

Processing requirements for the aforementioned tasks on a particular COTS server depends on various hardware features. Some of the COTS server parameters that have a substantial influence on the processing requirements include one or more of the following:
(1) CPU clock-speed;
(2) L2 cache size;
(3) Instruction cache size;
(4) Memory bandwidth; and
(5) Acceleration primitives for Encryption/Decryption.

In addition to the COTS server features, the nature of the traffic profiles also has a substantial implication on the processing requirements that include one or more of the following:

(1) Packet sizes;

(2) DES vs AES Encryption; and

(3) Upstream vs Downstream throughput

The relationships may utilize a three-dimensional table based on the vCore services, COTS server capabilities, and traffic profile parameters to estimate the processing requirements for various operating conditions. An exemplary table 1 may be determined based upon empirical data collection under various operating conditions with simulated traffic. Alternatively, mathematical models can be used to derive the same information based on data collected at specific operating conditions. Table 1 illustrates an exemplary one-dimensional table consisting of the processing times for various tasks for a given COTS server configuration and traffic profile.

TABLE 1

| | Average Time (ns) |
|---|---|
| tengig-output | 78.33 |
| tenGig-tx | 97.08 |
| bpi-encrypt | 86.67 |
| bpi encrypt bpi encrypt-deq | 795.83 |
| docsis classifier | 277.08 |
| docsis ds framer | 525.00 |
| docsis ds Qos Encqueue | 186.67 |
| docsis ds Qos Scheduler | 975.00 |
| docisi metatdata gen | 81.67 |
| dpdk input | 286.67 |
| ipv4 input no-checksum | 65.00 |
| ipv4 lookup | 55.00 |
| ipv4 rewrite | 46.67 |
| ipv6 lookup | 78.75 |
| ipv6 rewrite | 89.58 |
| loop21 output | 67.92 |
| Average time per packet (ns) | 3,792.92 |
| Mbps based on 1250 byte packets | 2,636.49 |

In table 1, the numbers represent the average % of the total processing chain for each sub-task on a single packet of a particular packet data size on a specific COTS server. These tasks and numbers may be measured in terms of CPU cycles for each task and scaled in accordance with the clock rate for the server to determine the average time duration for the entire list of sub-tasks providing the full processing time for a packet to work through the chain of processes. The inverse of the packet time represents the packets per second rate, this number multiplied by data per packet provide a bits per second estimate for this server under the specific packet size used. Of note is that the sub-task average time to process a packet may depend on the loading of the server and in particular the times will decrease as the server loading increases. The times should be measured under the condition of a heavily loaded (but not overloaded) server.

It should be also be noted that the average time per packet for each sub-task may vary widely depending on the COTS server hardware. For example, if the machine instructions for one subtask are too large to fit in the L1-cache for a model of server/CPU, the efficiency in completing that task will be negatively impacted and the average time increased. Using a model of this level detail is advantageous to understanding if processing bottlenecks may appear during the packet processing of the data. If, as example, the sub-task instructions become too large to fit into the L1-cache, it may be preferable to sub-divide the task into more than a single task and add an additional process sub-task into the overall chain.

Moreover, each functional block or various features in each of the aforementioned embodiments may be implemented or executed by a circuitry, which is typically an integrated circuit or a plurality of integrated circuits. The circuitry designed to execute the functions described in the present specification may comprise a general-purpose processor, a digital signal processor (DSP), an application specific or general application integrated circuit (ASIC), a field programmable gate array (FPGA), or other programmable logic devices, discrete gates or transistor logic, or a discrete hardware component, or a combination thereof. The general-purpose processor may be a microprocessor, or alternatively, the processor may be a conventional processor, a controller, a microcontroller or a state machine. The general-purpose processor or each circuit described above may be configured by a digital circuit or may be configured by an analogue circuit. Further, when a technology of making into an integrated circuit superseding integrated circuits at the present time appears due to advancement of a semiconductor technology, the integrated circuit by this technology is also able to be used.

It will be appreciated that the invention is not restricted to the particular embodiment that has been described, and that variations may be made therein without departing from the scope of the invention as defined in the appended claims, as interpreted in accordance with principles of prevailing law, including the doctrine of equivalents or any other principle that enlarges the enforceable scope of a claim beyond its literal scope. Unless the context indicates otherwise, a reference in a claim to the number of instances of an element, be it a reference to one instance or more than one instance, requires at least the stated number of instances of the element but is not intended to exclude from the scope of the claim a structure or method having more instances of that element than stated. The word “comprise” or a derivative thereof, when used in a claim, is used in a nonexclusive sense that is not intended to exclude the presence of other elements or steps in a claimed structure or method.

1. A cable distribution system comprising:
(a) a head end connected to a plurality of customer devices through a transmission network that includes a first remote physical device, where said first remote physical device includes remote physical layer processing, that processes received data for said plurality of customer devices, where said head end includes at least one server each of which includes a respective processor;
(b) a first vCore instantiated on one of said servers of said head end configured to provide services to said plurality of customer devices through said first remote physical device;
(c) a second vCore instantiated on one of said servers of said head end not configured to provide services to said plurality of customer devices through said first remote physical device;
(d) a monitoring system that reconfigures with configuration information the combination of said second vCore and said first remote physical device to provide services to said plurality of customer devices through said first remote physical device, and said monitoring system reconfigures said first vCore to not provide services to said plurality of customer devices through said first remote physical device, where said reconfigures with said configuration information said combination of said second vCore and said first remote physical device to said provide services to said plurality of customer devices through said first remote physical device in a manner where said first remote physical device does not loose precision timing protocol synchronization during said reconfigures, where said first vCore includes a virtual IP address that is used for communication with said first remote physical device and said second vCore uses said virtual IP address for communication with said first remote physical device, where said first vCore includes a first physical IP address associated with a first network interconnection that is used for communication with said first remote physical device, where said second vCore includes a second physical IP address associated with a first network interconnection that is used for communication with said first remote physical device.

2. The cable distribution system of claim 1 wherein said reconfiguration of said second vCore includes at least one of Remote Physical Layer (PHY) Medium Access Control (MAC) (R-PHY MAC) Core configuration and data plane configuration.

3. The cable distribution system of claim 1 wherein said second vCore is configured to provide services to an additional plurality of customer devices through a second remote physical device, while also providing services to said plurality of customer devices through said first remote physical device.

4. The cable distribution system of claim 3 wherein said first vCore is configured to provide services to a further plurality of customer devices through a third remote physical device.

5. The cable distribution system of claim 1 wherein said first vCore operates on a first one of said servers and said second vCore operates on said first one of said servers.

6. The cable distribution system of claim 1 wherein said first vCore operates on a first one of said servers and said second vCore operates on a second one of said servers.

7. The cable distribution system of claim 1 said first vCore has an associated IP address and said second vCore is assigned the same IP address as said first vCore.

8. The cable distribution system of claim 1 wherein said configuration information includes at least one of (1) Data Over Cable Service Interface Specification (DOCSIS), (2) radio frequency (RF), (3) remote physical device (RPD), (4) cable Medium Access Control (cable-MAC), (5) Internet Protocol (IP) addressing, (6) and routing.

9. The cable distribution system of claim 1 wherein said configuration information includes at least one of (1) Remote Physical Layer (RPHY) Medium Access Control (MAC (R-PHY MAC) Core, (2) Central Processing Unit Core Identifiers (CPU Core Ids), (3) data plane network virtual functions (VF) addresses, (4) MAC addresses for interfaces, (5) encryption VFs, and (6) memory allocation.

10. The cable distribution system of claim 1 wherein said configuration information includes at least one of (1) log information of said first vCore, (2) log information of one of said servers, and (3) log information of said remote physical device.

11. The cable distribution system of claim 1 wherein said configuration information includes at least one of (1) identification of said remote physical device associated with said first vCore and (2) parameters of said remote physical device associated with said first vCore.

12. The cable distribution system of claim 1 wherein said configuration information includes layer 2 tunneling protocol sequence numbers.

13. The cable distribution system of claim 1 wherein said first vCore includes a plurality of virtual IP addresses.

14. The cable distribution system of claim 13 wherein said second vCore includes one of said plurality of virtual IP addresses as a result of said reconfiguration.

15. The cable distribution system of claim 1 wherein said first vCore is a virtual cable modem termination system.

16. The cable distribution system of claim 15 wherein said second vCore is a virtual cable modem termination system.
